(19) United States
(12) Patent Application Publication
(10) Pub. No.: US 2014/0006302 A1
(43) Pub. Date: Jan. 2, 2014

(54) ACCESS SYSTEM AND METHOD

(71) Applicant: GENERAL ELECTRIC COMPANY, Schenectady, NY (US)

(72) Inventors: Edward McQuillan, Lisle, IL (US); Paul Robert Emmerich De Mello, Austin, TX (US); Albert Mary Henry Stoffels, Austin, TX (US); Adam A. Alfar, Austin, TX (US); Michael Ciarleglio, Austin, TX (US)

(21) Appl. No.: 13/920,776

(22) Filed: Jun. 18, 2013

Related U.S. Application Data
(60) Provisional application No. 61/666,295, filed on Jun. 29, 2012.

(51) Int. Cl. G06Q 10/08

(52) U.S. Cl. CPC G06Q 10/083
USPC 705/337

(57) ABSTRACT

Systems and methods for facilitating the self check-in and/or the self check-out of an operator of a shipping vehicle at a shipping terminal. A gate kiosk located at a gate of a shipping terminal is provided which operably interfaces with a terminal management controller that manages transactions taking place within a shipping terminal. An operator may enter information and make various selections via user interface of the gate kiosk to check in and/or check out of the shipping terminal with a shipping container or trailer, without leaving the shipping vehicle.

This U.S. patent application claims priority to and the benefit of provisional U.S. patent application Ser. No. 61/666,295 filed on Jun. 29, 2012, which is incorporated herein by reference in its entirety.

### BACKGROUND

1. Technical Field

The subject matter disclosed herein relates to methods and systems for access systems, such as a drayage driver check-in/check-out at a terminal, yard, or distribution center.

2. Discussion of Art

Today, when drivers of shipping vehicles bring shipments to or take shipments from a shipping terminal, the drivers may be checked in or checked out of the shipping terminal by another person to process the shipments in and out of the shipping terminal. That same person, or an additional person, may inspect an associated shipping container or trailer to check for defects as part of the check-in or check-out process. A driver of a shipping vehicle may have to exit the shipping vehicle to check in or check out of the shipping terminal. For example, a driver may have to exit his vehicle and enter an office at the entrance gate or exit gate of a shipping terminal and verbally provide certain information to a person within the office in order to check in or check out. Such current check-in and check-out procedures can consume time and manpower, resulting in substantial costs to the shipping terminal owner, the driver's transportation or drayage company, and/or others. It may be desirable to have a system or method that differs from those that are currently available.

### BRIEF DESCRIPTION

Systems and methods for facilitating the self check-in/check-out of a driver of a shipping vehicle at a shipping terminal are disclosed. Embodiments of the invention provide a gate kiosk to facilitate self check-in/check-out.

In one embodiment, a system includes a terminal management controller operable to manage transactions taking place within a shipping terminal, and a gate kiosk, having a user interface to facilitate the self check-in and/or self check-out of an operator of a shipping vehicle arriving at and/or leaving the shipping terminal to deliver or depart with one or more shipping units. For example, “facilitate” may mean that the user interface, in at least one mode of operation, provides functionality for an operator to self check-in and/or self check-out. The user interface may provide indicia and/or controls that, through communication with the terminal management controller and interaction with and by the operator, allows the operator to check-in and/or check-out (e.g., in relation to a scheduling database or other data list) without a need for the presence of other humans at the locations of the gate kiosk to effectuate the check-in and/or check-out.

In embodiments, the gate kiosk includes a printer operable to print an equipment interchange receipt (EIR) to memorialize delivery and/or pick-up of the one or more shipping units. Further, the user interface may include one or more of a touchscreen display, a keyboard, or a voice recognition interface operable to allow a user to make selections and/or enter information. The gate kiosk may include a radiation detector operable to detect radiation emitted by a shipping vehicle and/or a shipping unit. The gate kiosk may include a chemical vapor detector operable to detect chemical vapors emitted by a shipping vehicle and/or a shipping unit. The system may further include an ingress/egress controller coupled to the gate kiosk and operable to open or close a gate associated with the gate kiosk at the command of the gate kiosk. The system alternatively may include an ingress/egress controller coupled to the terminal management controller and operable to open or close a gate associated with the gate kiosk at the command of the terminal management controller. The gate kiosk may be positioned at a gate of the shipping terminal. The gate kiosk may be positioned at a height and with respect to a roadway by the gate to allow for operator access of the user interface through a driver side window of a cab of the shipping vehicle and without the operator leaving the cab. The gate kiosk may automatically populate one or more data fields of the user interface associated with the self check-in and/or the self check-out based on first information received from the terminal management controller responsive to communication from the gate kiosk to the terminal management controller of second information entered by the operator via the user interface. The one or more data fields that are populated may include one or more data fields of the user interface that the operator would have to fill in for the self check-in and/or the self check-out but for the automatic population.

In one embodiment, a method includes receiving information selected at and/or entered into a gate kiosk at a gate of a shipping terminal as part of a self check-in process or a self check-out process. The information may be received by an operator of a shipping vehicle transporting one or more shipping units. The received information may be selected at and/or entered into the gate kiosk via one or more of a touch screen, a voice recognition interface, or a keyboard, for example. The method also includes processing the received information to validate a delivery or a pick-up of the one or more shipping units by the operator of the shipping vehicle.

In other embodiments, the method may include searching a database for waybill information associated with the received information and automatically populating one or more data fields associated with the self check-in process and/or the self check-out process with at least a portion of the associated waybill information. The method may include printing an EIR in response to completing the self check-in process or the self check-out process. The method may include opening the gate in response to completing the self check-in process or the self check-out process, allowing the shipping vehicle to pass through the gate. The method may include automatically receiving information from the shipping vehicle and/or the one or more shipping units into the gate kiosk without the operator having to select or enter the information.

In one embodiment, a system is provided that includes means for a driver of a shipping vehicle, transporting one or more shipping units, to select or enter information at an entrance gate or an exit gate of a shipping terminal without leaving a driver seat of the shipping vehicle (e.g., a user interface on a gate kiosk). The system also includes means for receiving the selected or entered information (e.g., a computer network), and means for processing the received information (e.g., a terminal management software application on a terminal management controller) to determine if a gate of the shipping terminal blocking the shipping vehicle should or should not be opened to allow the driver to enter or leave the shipping terminal while driving the shipping vehicle. The system may include means for printing an EIR (e.g., a printer). The system may include means for detecting radiation (e.g., a radiation detector) emitted by the shipping vehicle or the one or more shipping units, or means for detecting chemical vapors (e.g, a chemical detector) emitted by the shipping vehicle or the one or more shipping units. The system may include means for automatically receiving information from the shipping vehicle or the one or more shipping units without the driver having to select or enter the information (e.g., an Automatic equipment identification (AEI) system). The system may include means for accessing waybill information associated with the driver, the shipping vehicle, or the one or more shipping units (e.g., the terminal management controller).

### BRIEF DESCRIPTION OF THE DRAWINGS

Reference is made to the accompanying drawings in which particular embodiments of the invention are illustrated as described in more detail in the description below, in which:

FIG. 1 is a schematic block diagram of an exemplary embodiment of a system providing self check-in and self check-out of a driver of a shipping vehicle arriving at or leaving a gate of a shipping terminal with a shipping container or trailer;

FIG. 2 illustrates a flow chart of an exemplary embodiment of a method of self check-in of a driver of a shipping vehicle arriving at a gate of a shipping terminal with a shipping container or trailer using the system of FIG. 1;

FIGS. 2A-2V illustrate exemplary embodiments of screens or panels associated with the method of self check-in of FIG. 2 and provided by the system of FIG. 1;

FIG. 3 illustrates a flow chart of an exemplary embodiment of a method of self check-out of a driver of a shipping vehicle leaving from a gate of a shipping terminal with a shipping container or trailer using the system of FIG. 1;

FIGS. 3A-3D illustrate exemplary embodiments of screens or panels associated with the method of self check-out of FIG. 3 and provided by the system of FIG. 1; and

FIG. 4 illustrates an exemplary embodiment of a screen or panel provided by the system of FIG. 1 associated with configuring a gate kiosk of the system of FIG. 1.

### DETAILED DESCRIPTION

Embodiments of the invention relate to methods and systems for facilitating the self check-in/check-out of a driver of a shipping vehicle at a shipping terminal.

As used here, the terms “container” and “trailer” may be used interchangeably herein and refer to a storage medium configured to hold products, goods, or other shippable materials. Such products, goods, or other shippable materials are referred to herein as “shipping units”.

The terms “shipping terminal” refers to a location and/or facility where products, goods, or other shippable materials are shipped into and subsequently shipped out of by drivers of shipping vehicles.

The term “kiosk” refers to a structure with an associated interactive information gateway.

“Software” or “computer program” refer to computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions.

“Computer” or “processing element” or “computer device” as used herein includes, but is not limited to, any programmed or programmable electronic device that can store, retrieve, and process data. “Non-transitory computer-readable media” include, but are not limited to, a CD-ROM, a removable flash memory card, a hard disk drive, a magnetic tape, and a floppy disk.

“Computer memory”, as used herein, refers to a storage device configured to store digital data or information which can be retrieved by a computer or processing element.

“Controller”, as used herein, refers to the logic circuitry and/or processing elements and associated software or program involved in controlling transactions taking place within a shipping terminal.

The terms “signal”, “data”, and “information” may be used interchangeably herein and may refer to digital or analog forms.

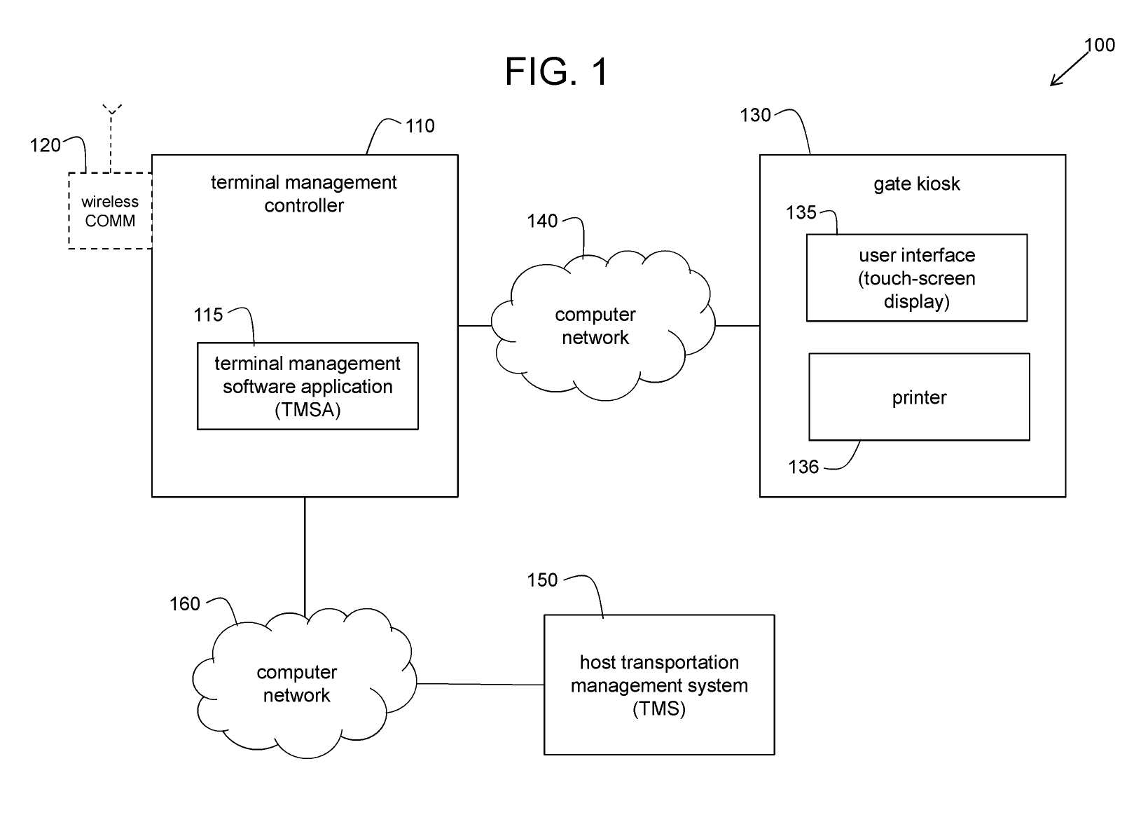

FIG. 1 is a schematic block diagram of an exemplary embodiment of a system 100 providing self check-in and self check-out of a driver of a shipping vehicle arriving at or leaving a gate of a shipping terminal with a shipping container or trailer. The shipping terminal may be, for example, a railroad intermodal terminal, a yard, a loading/unloading dock, a distribution center, or any location and/or facility where products, goods, or other shippable materials are shipped into and subsequently shipped out of by drivers of shipping vehicles. The containers or trailers containing the products, goods, or materials are processed in and out of the shipping terminal. A gate of a shipping terminal is a checkpoint that a driver pulls up to, to check in and/or check out of the shipping terminal. The gate checkpoint may include a physical gate that opens and closes, allowing or preventing a driver from proceeding.

The system may include a terminal management controller 110 operable to manage transactions taking place within a shipping terminal. In accordance with an embodiment, the terminal management controller is implemented as a server computer running a terminal management software application (TMSA) 115. The terminal management controller manages transactions that take place within the shipping terminal (e.g., deliveries to the shipping terminal, pick-ups from the shipping terminal, movement of containers and trailers within the shipping terminal, and the like).

As an option, the system may include a wireless communication (COMM) device 120 operably interfacing to the server computer and configured to communicate with other wireless devices (e.g., via radio frequency communication) operating within the shipping terminal. Such other wireless devices may be hand-held devices used by inspectors, or may be located in cranes or other on-site transportation vehicles within the shipping terminal, and are configured to communicate with the terminal management controller.

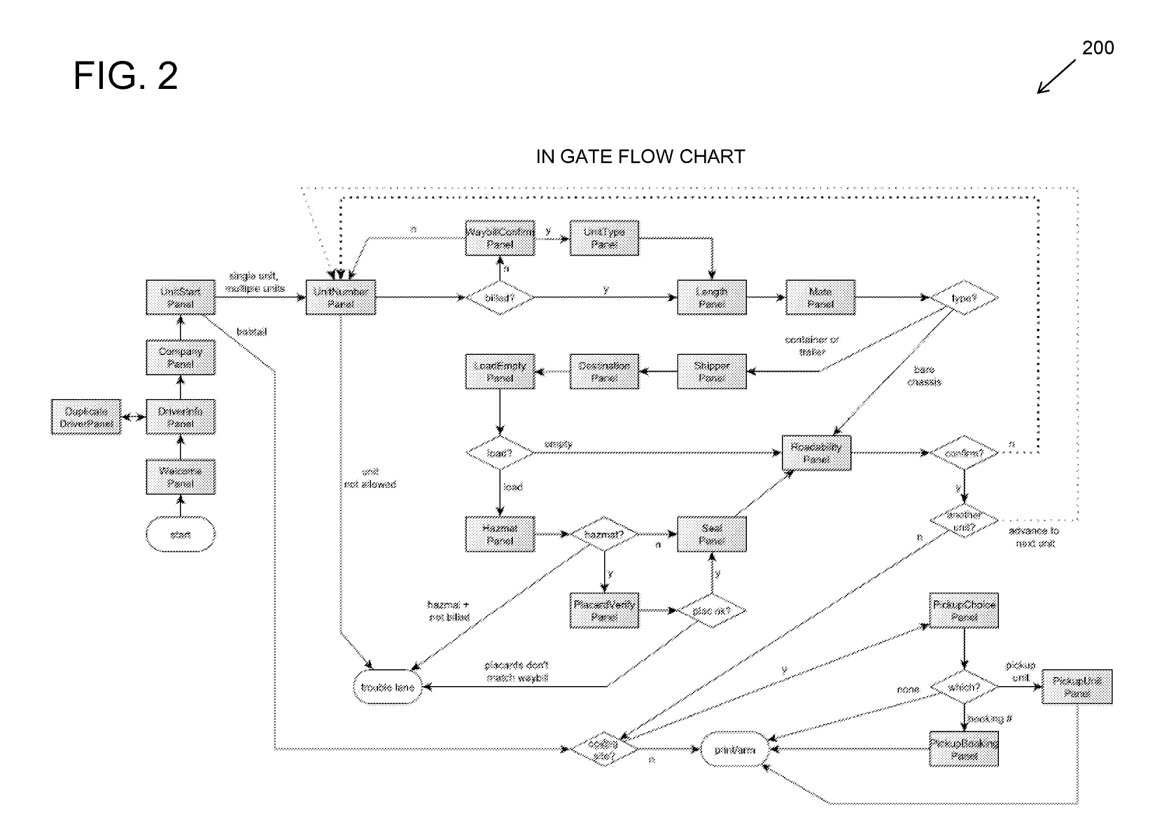

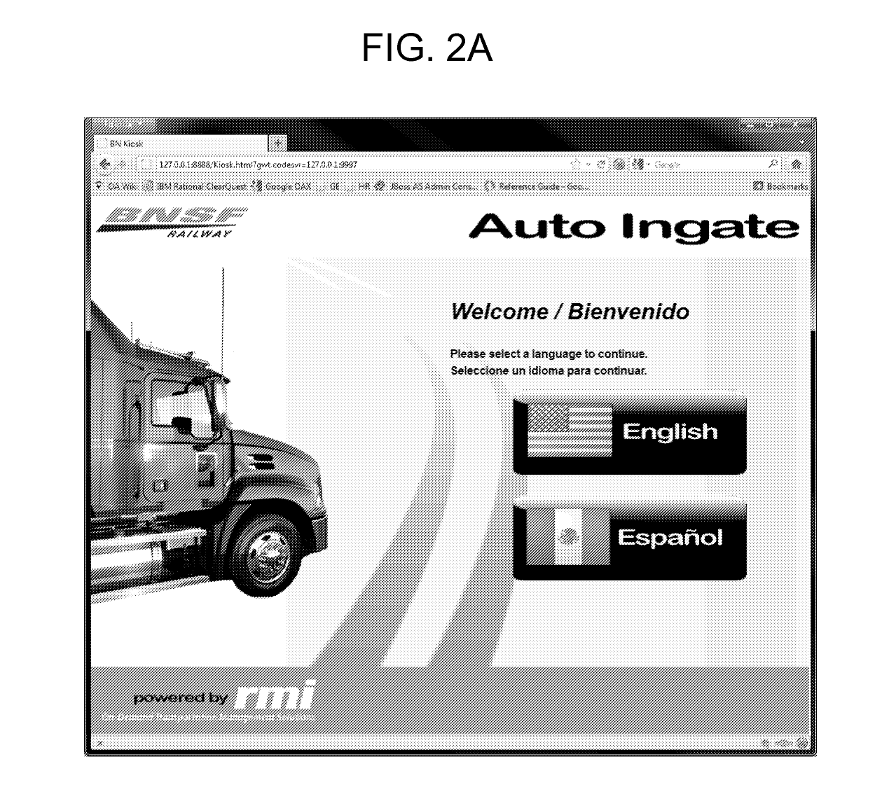

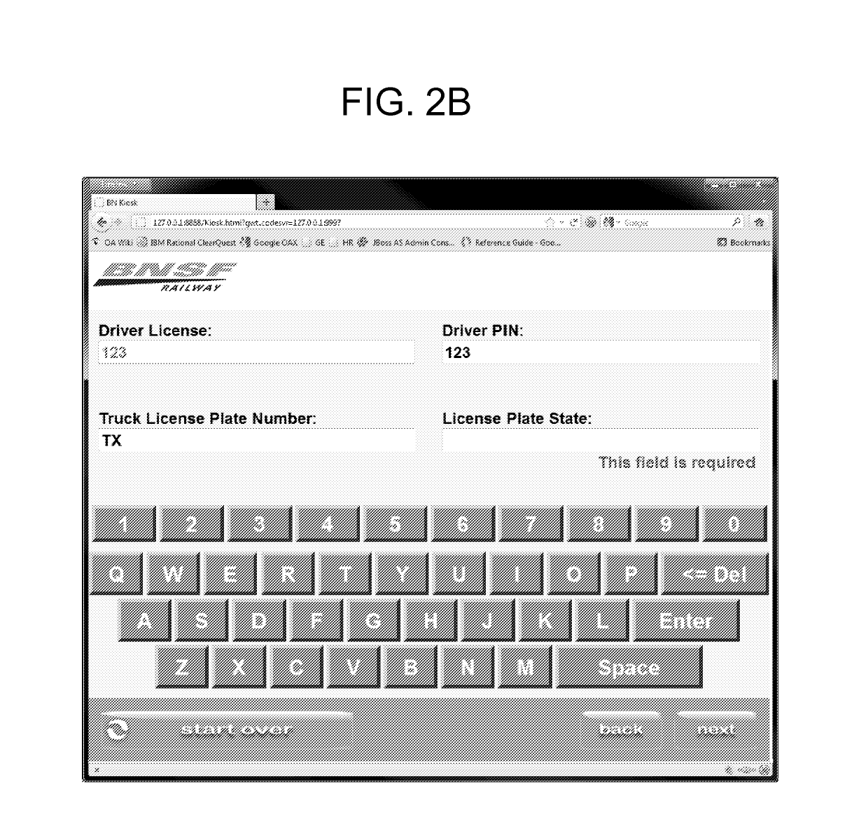

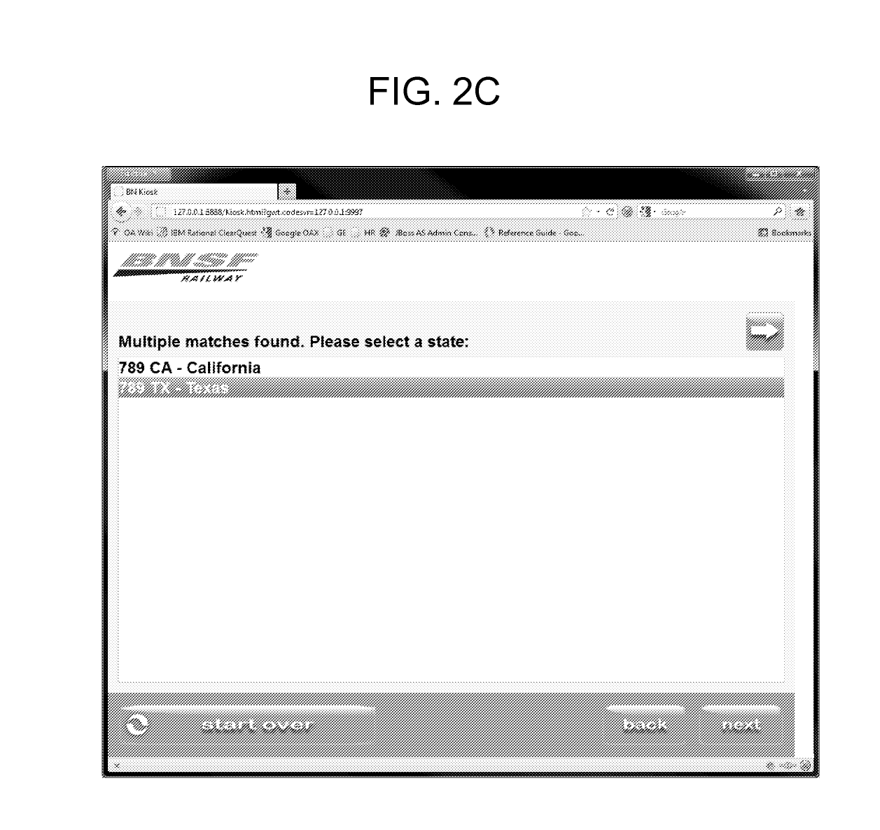

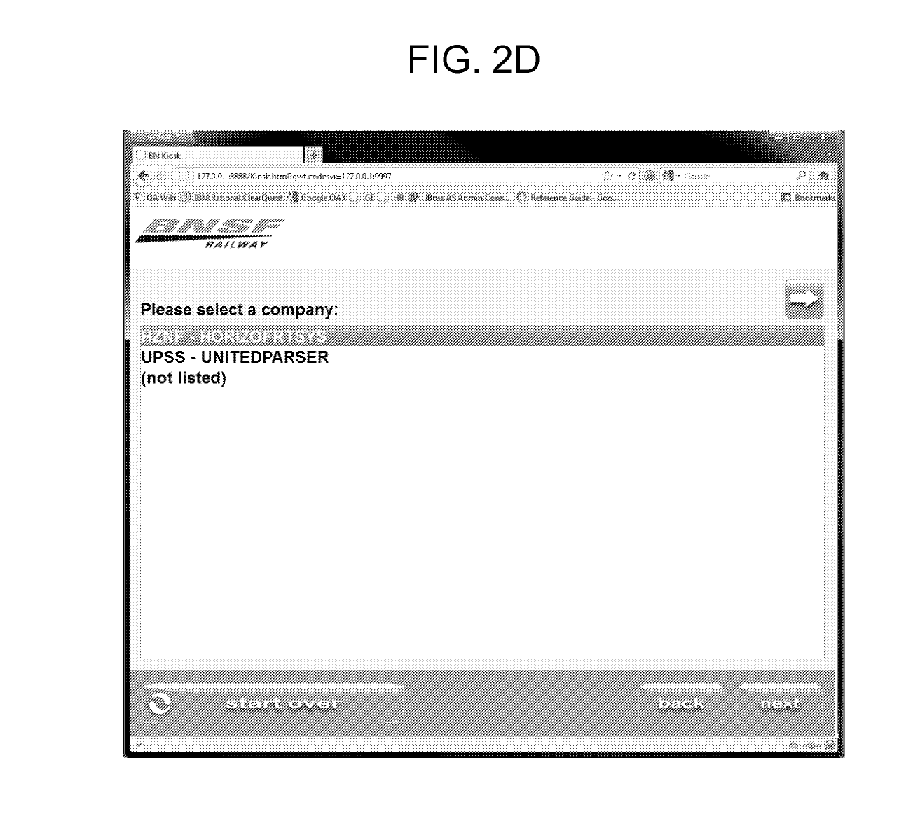

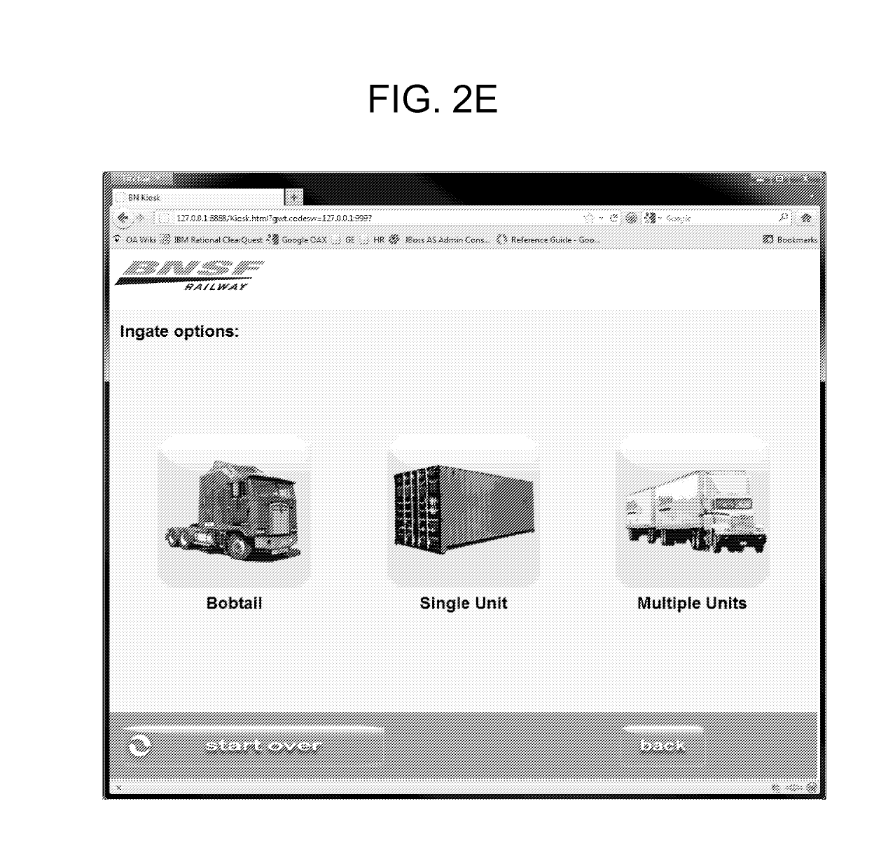

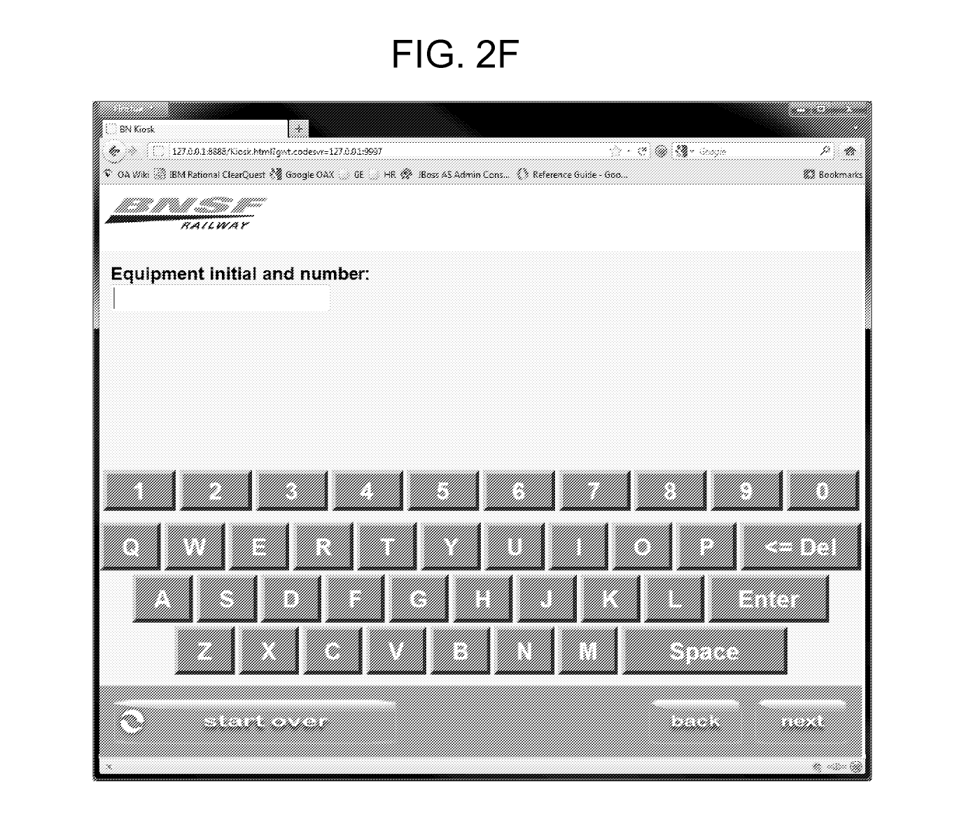

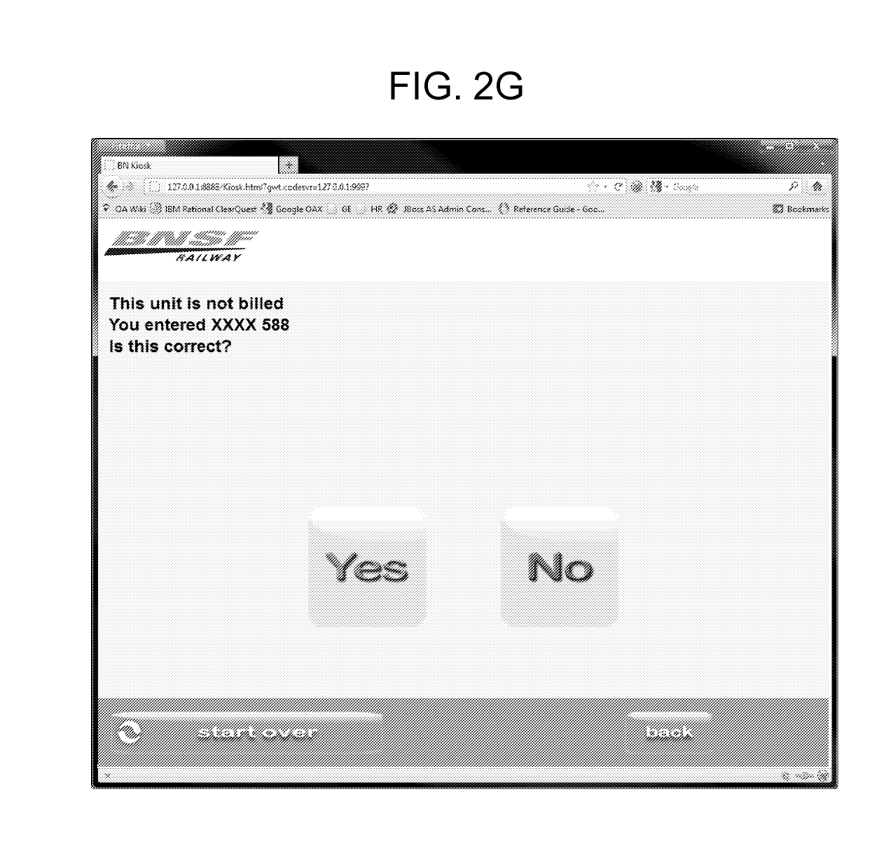

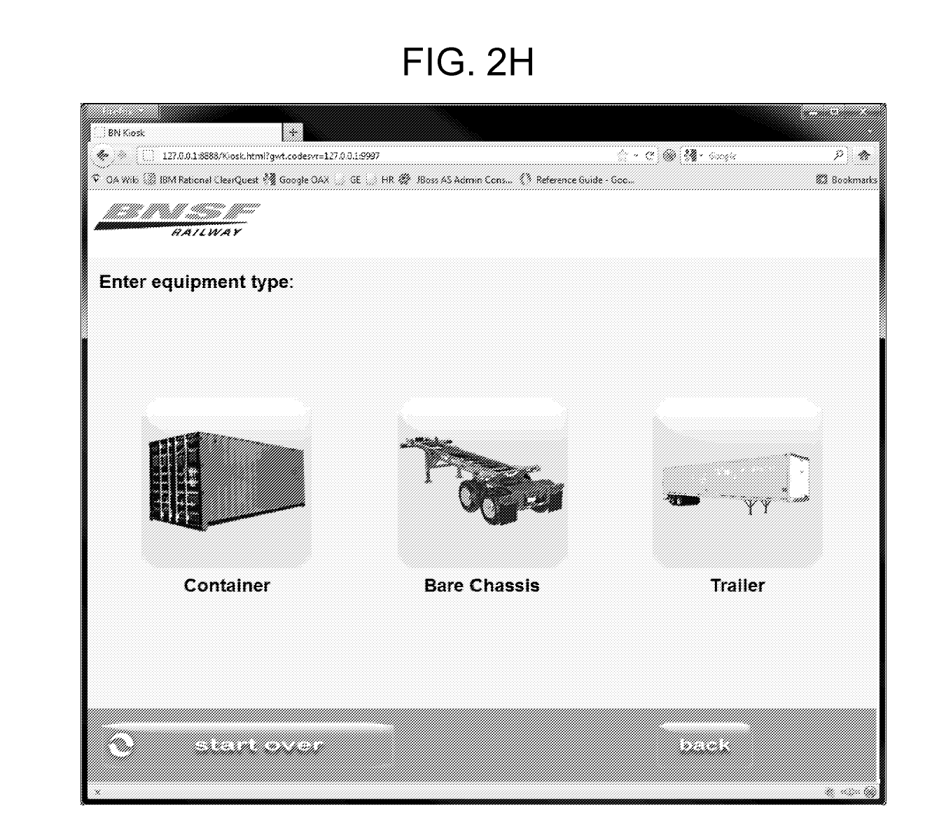

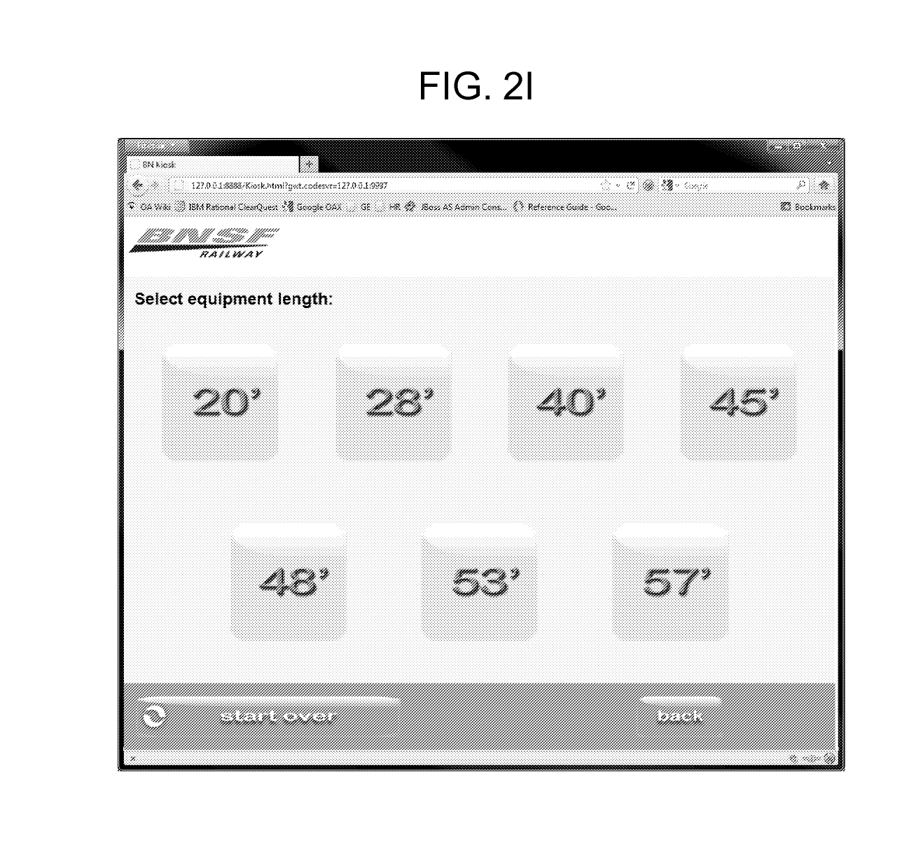

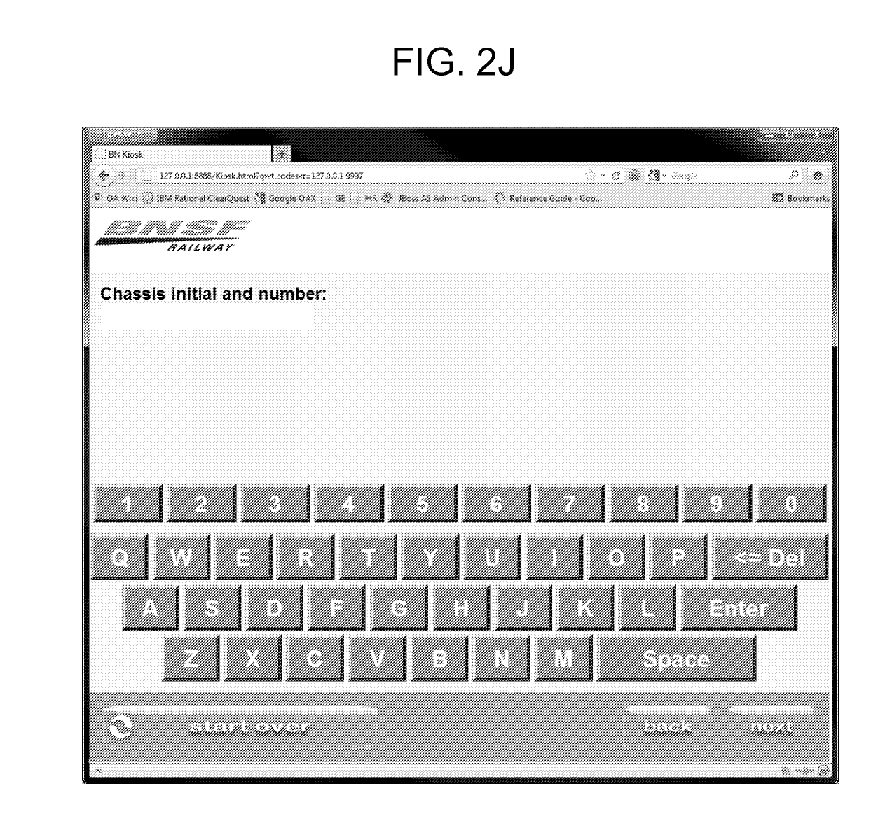

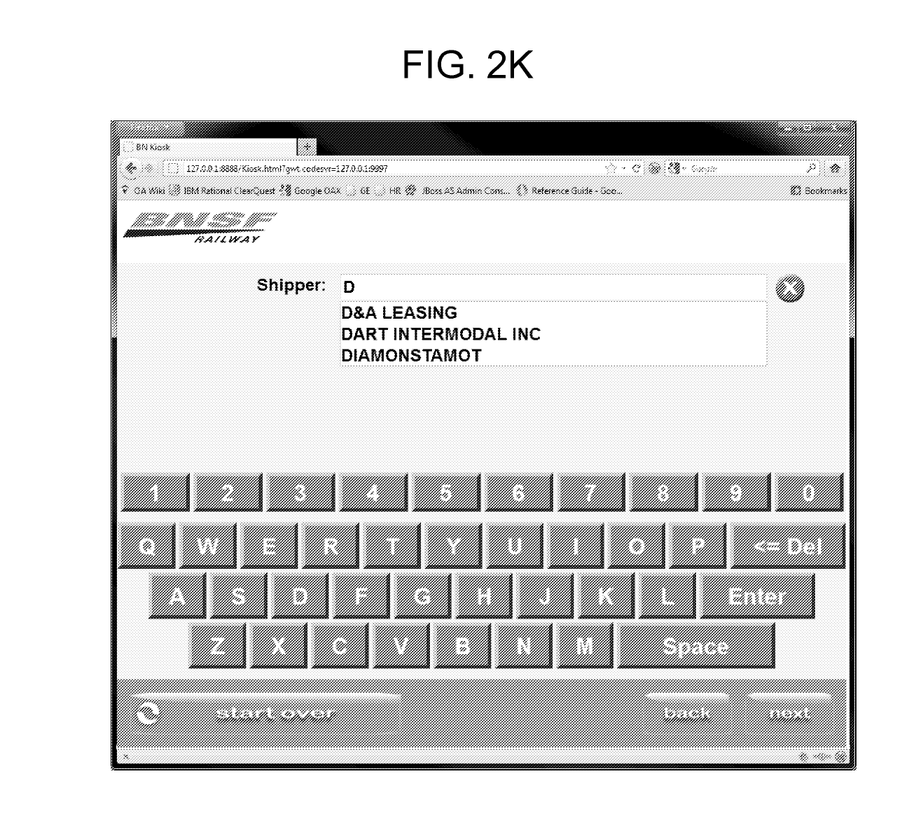

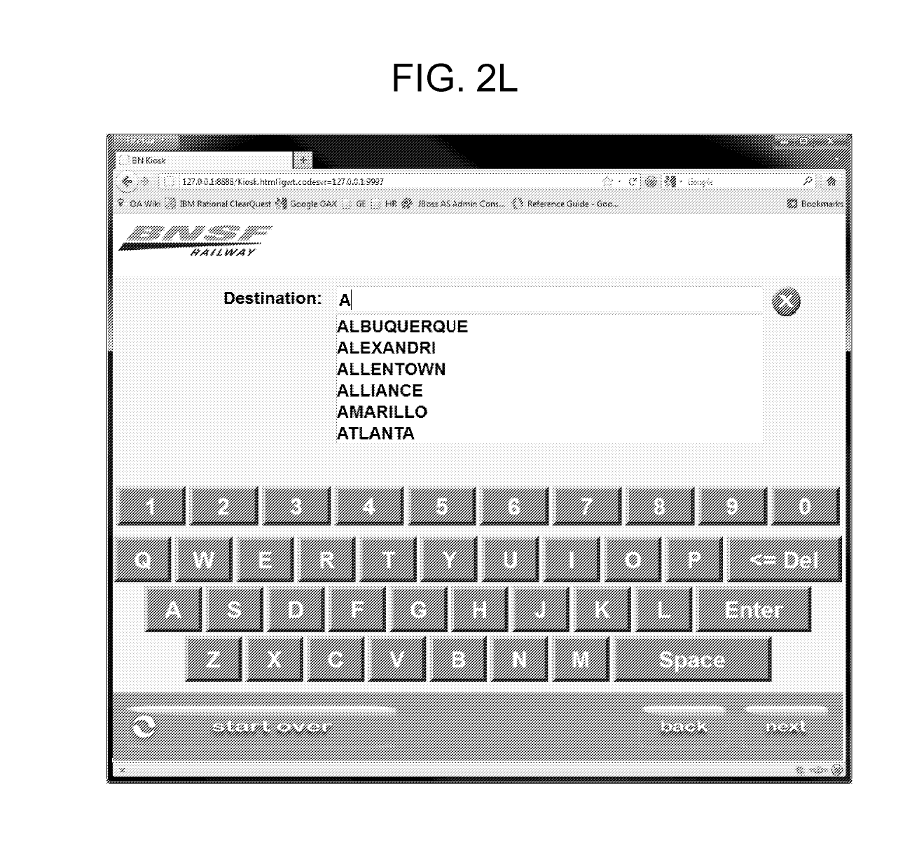

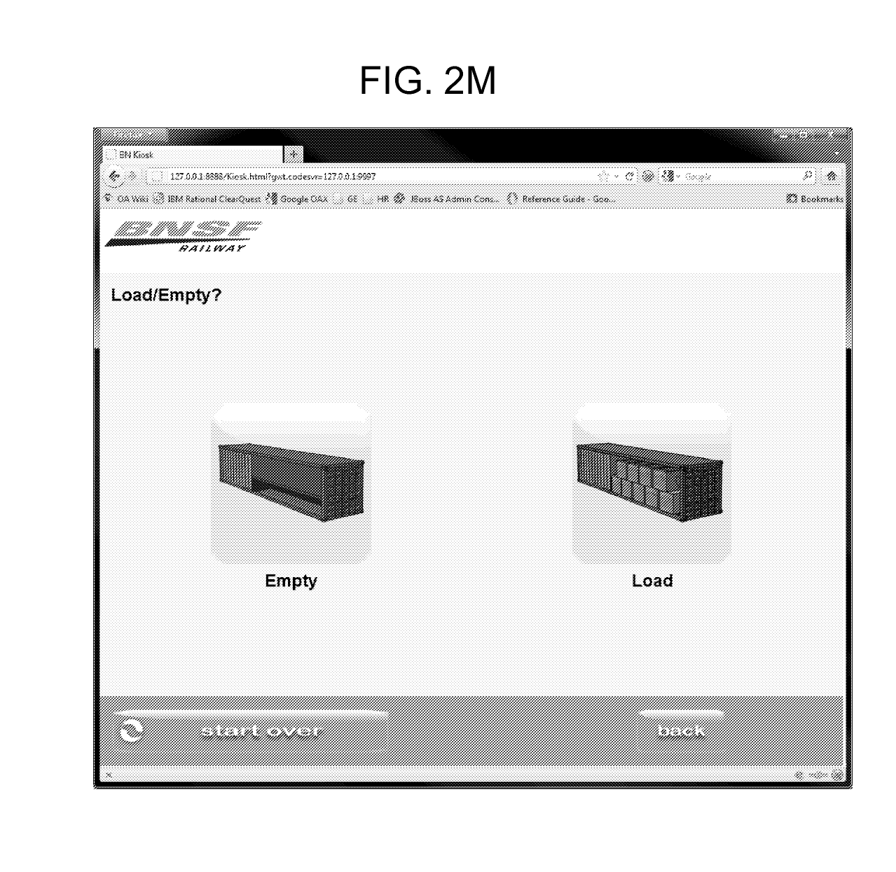

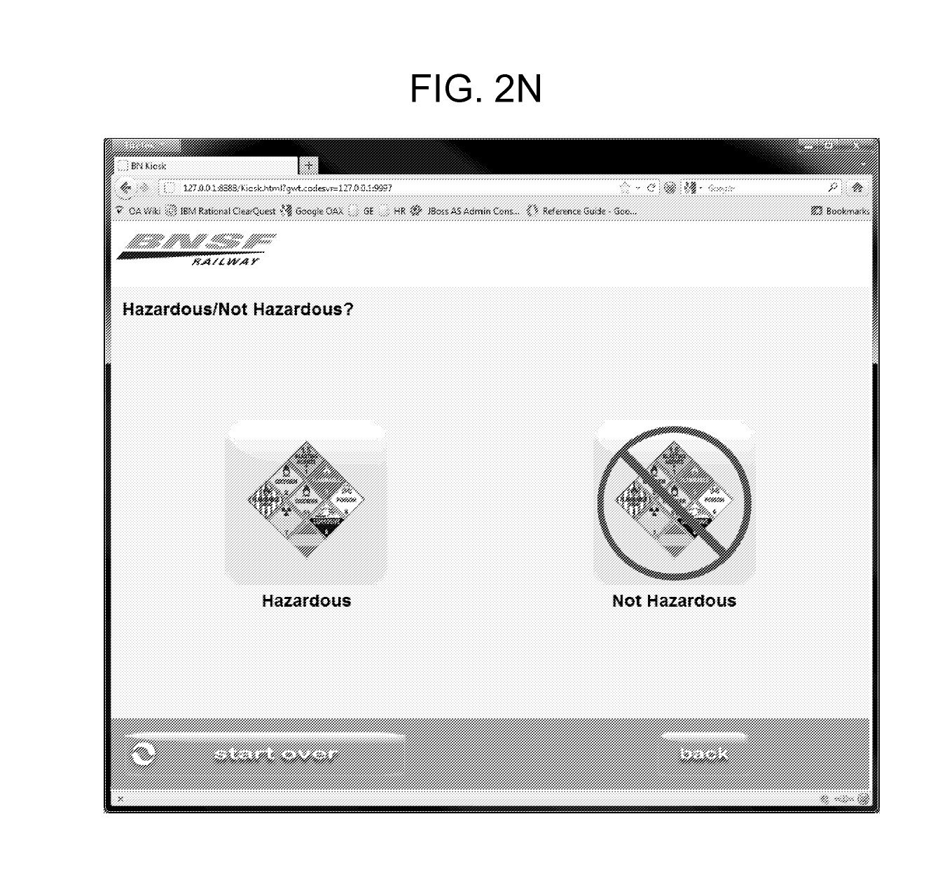

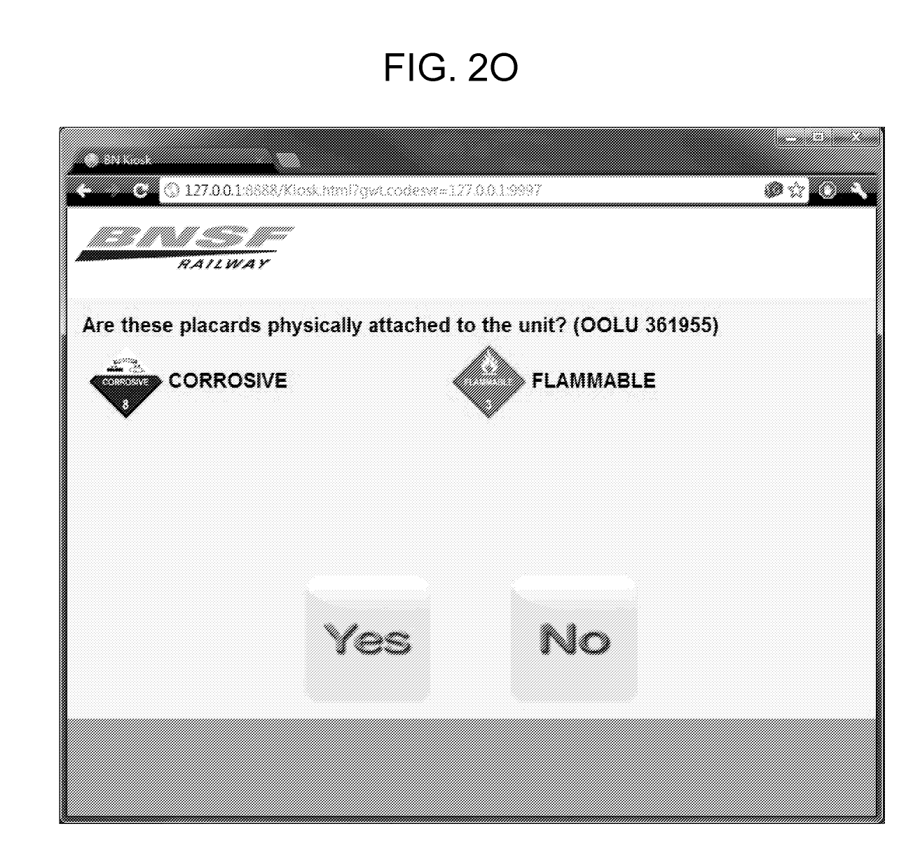

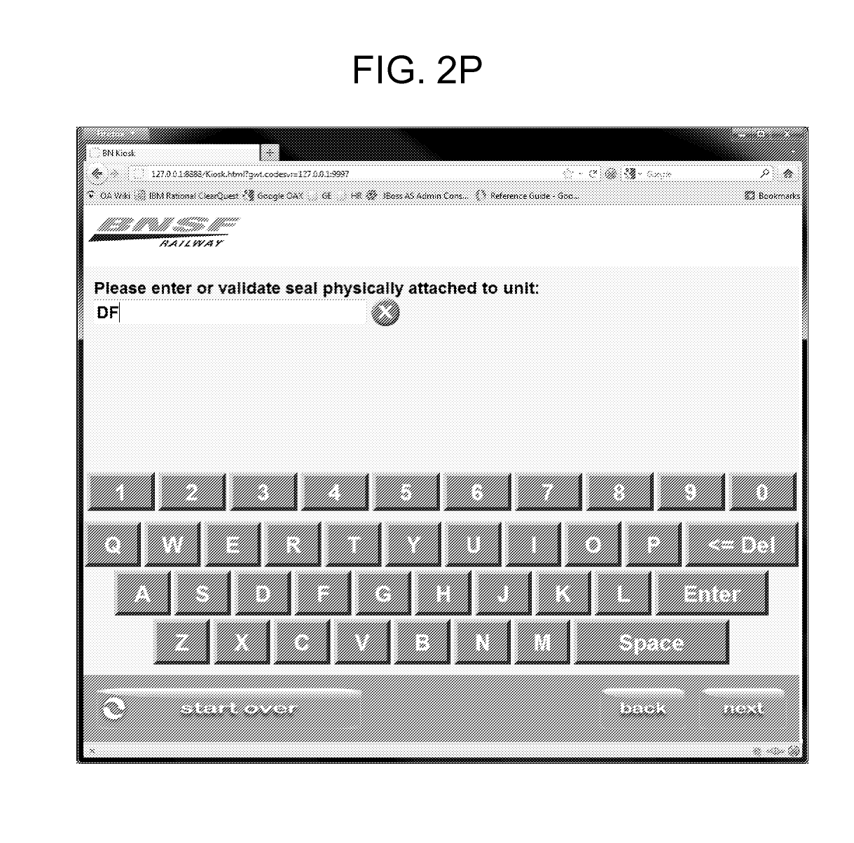

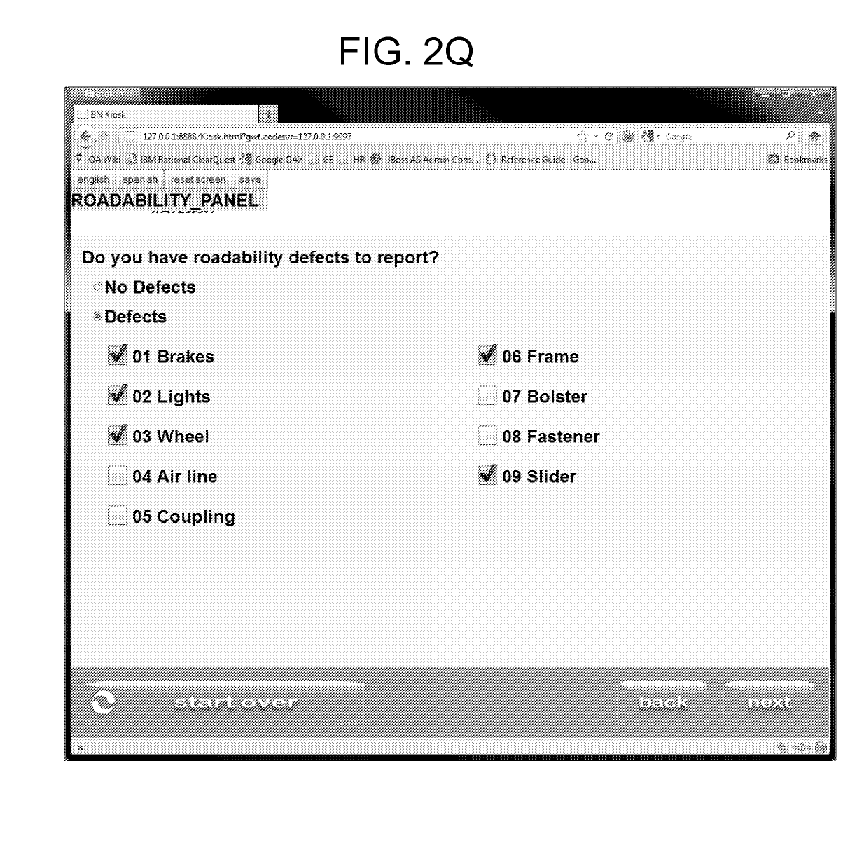

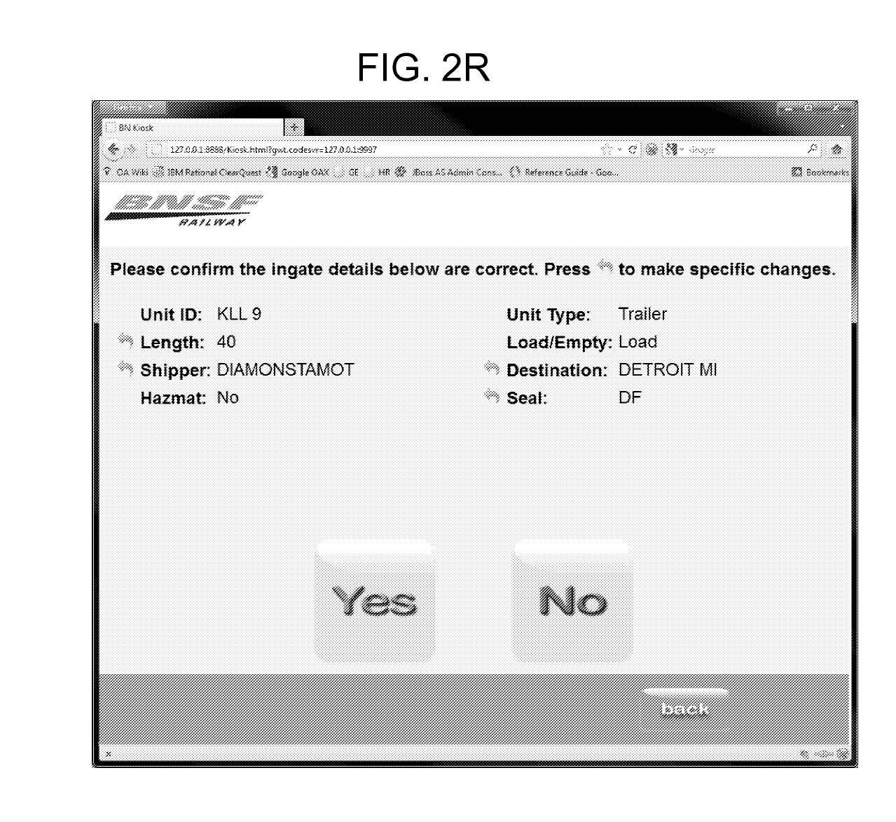

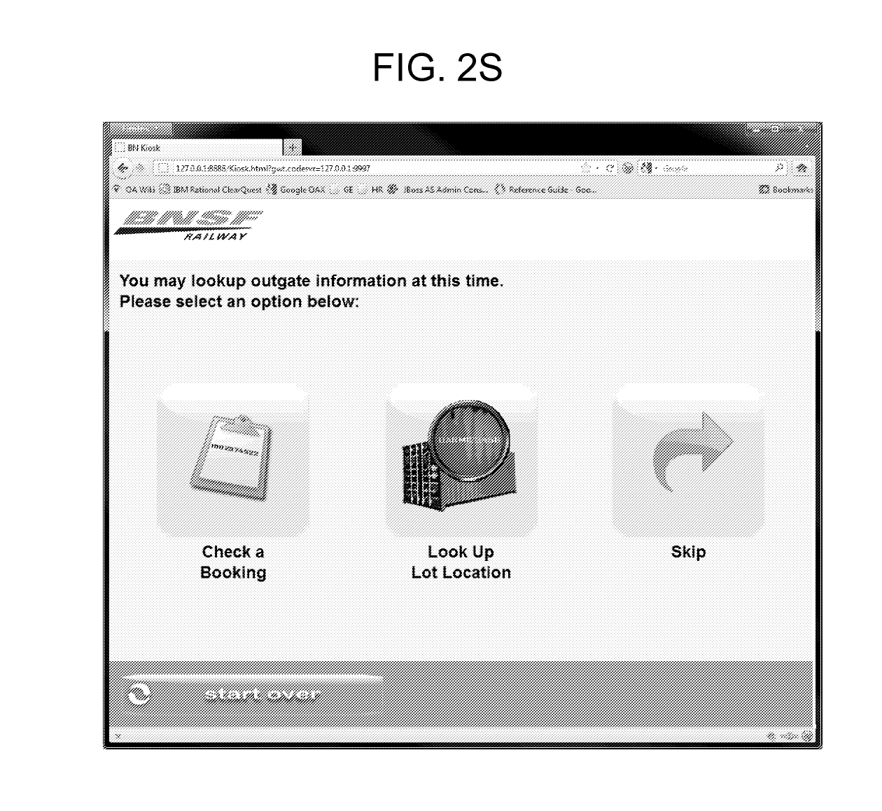

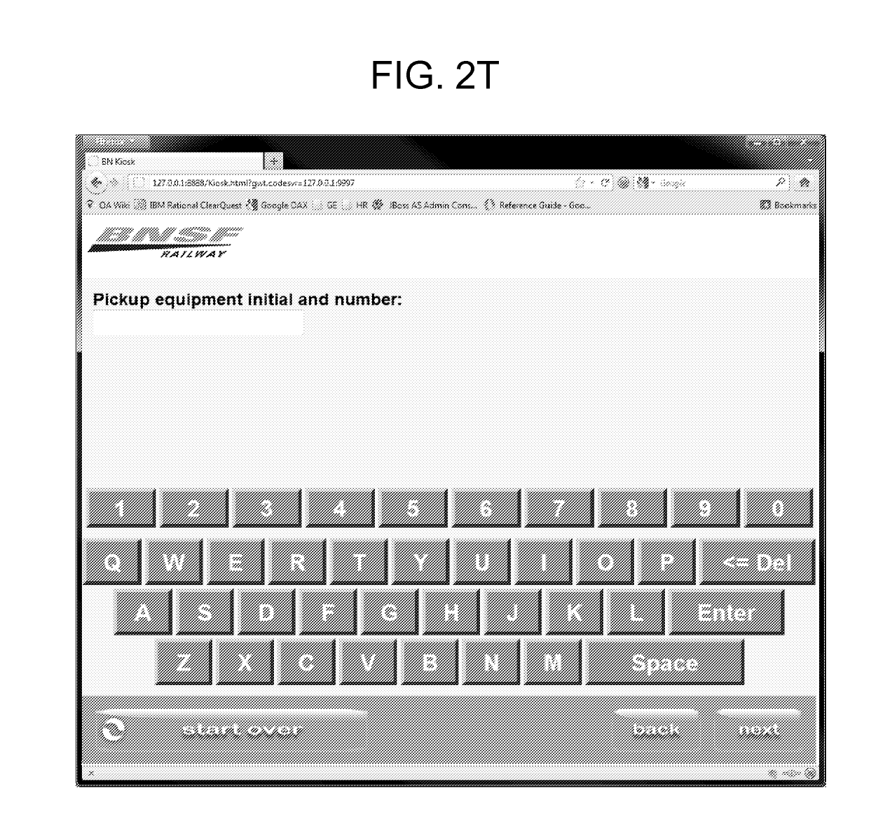

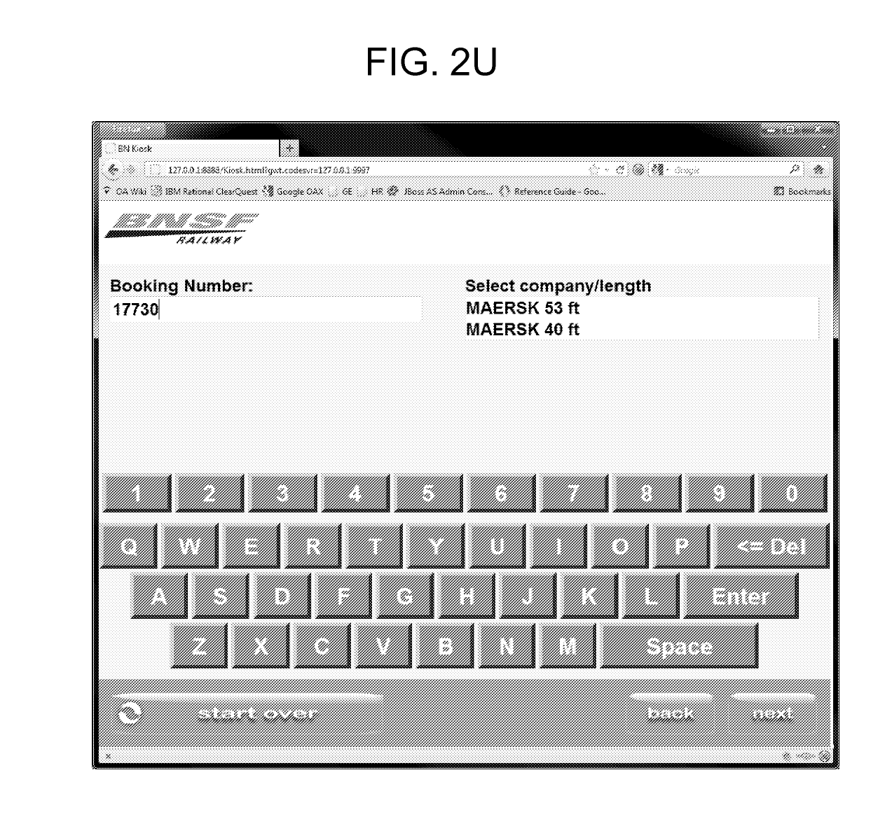

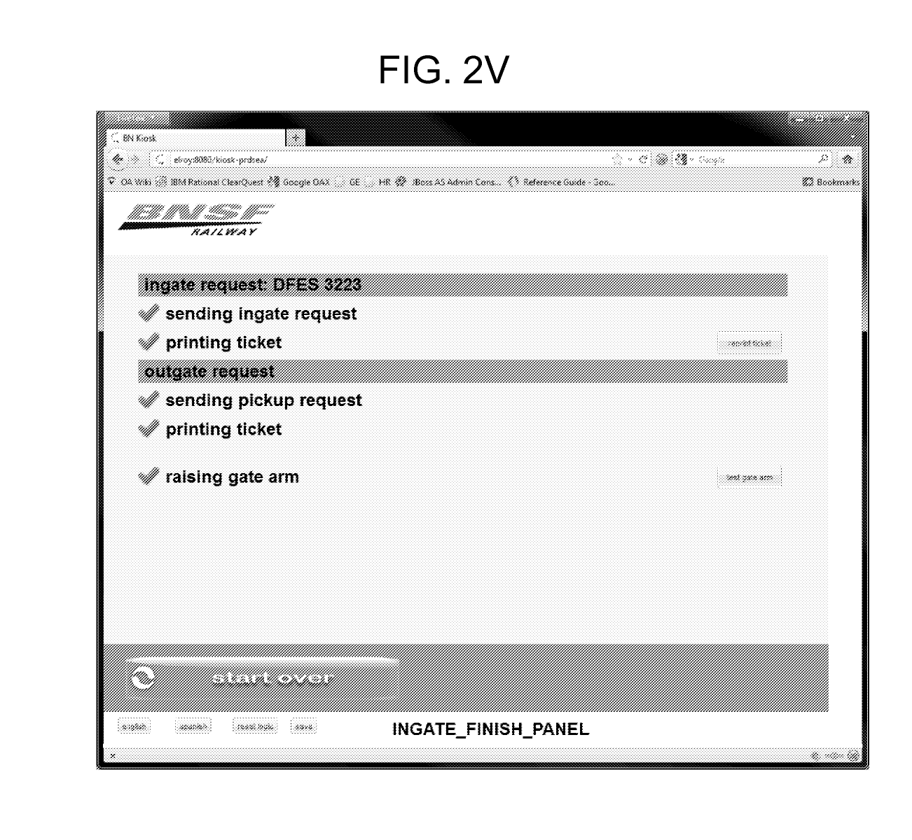

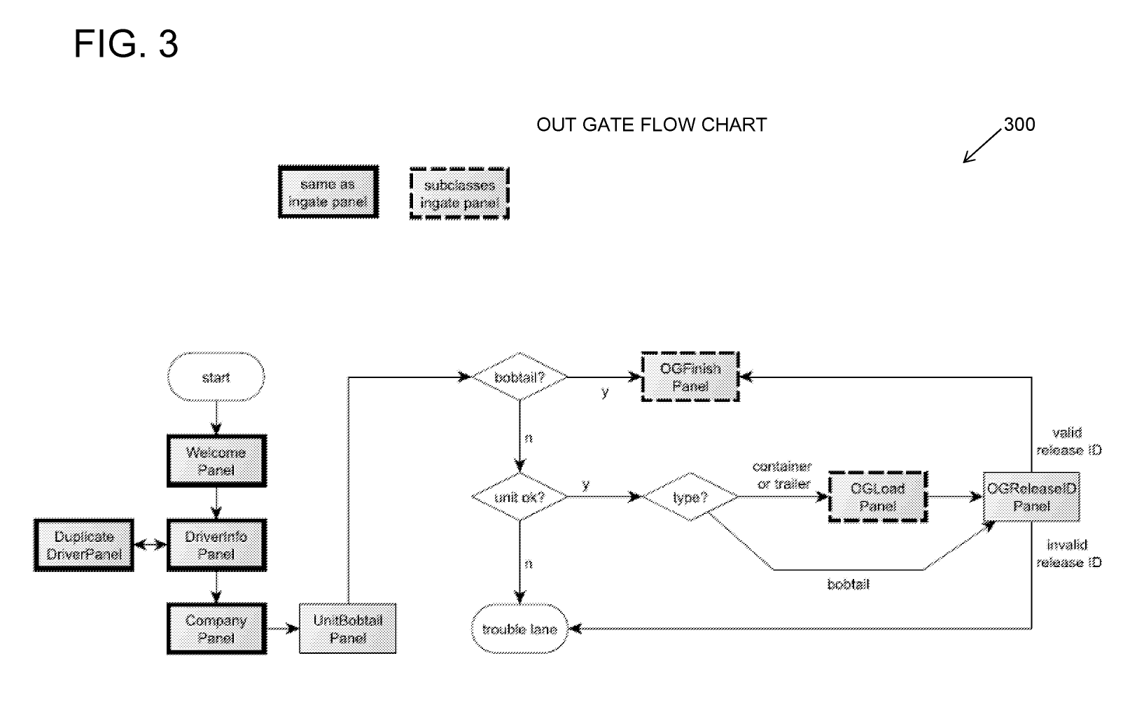

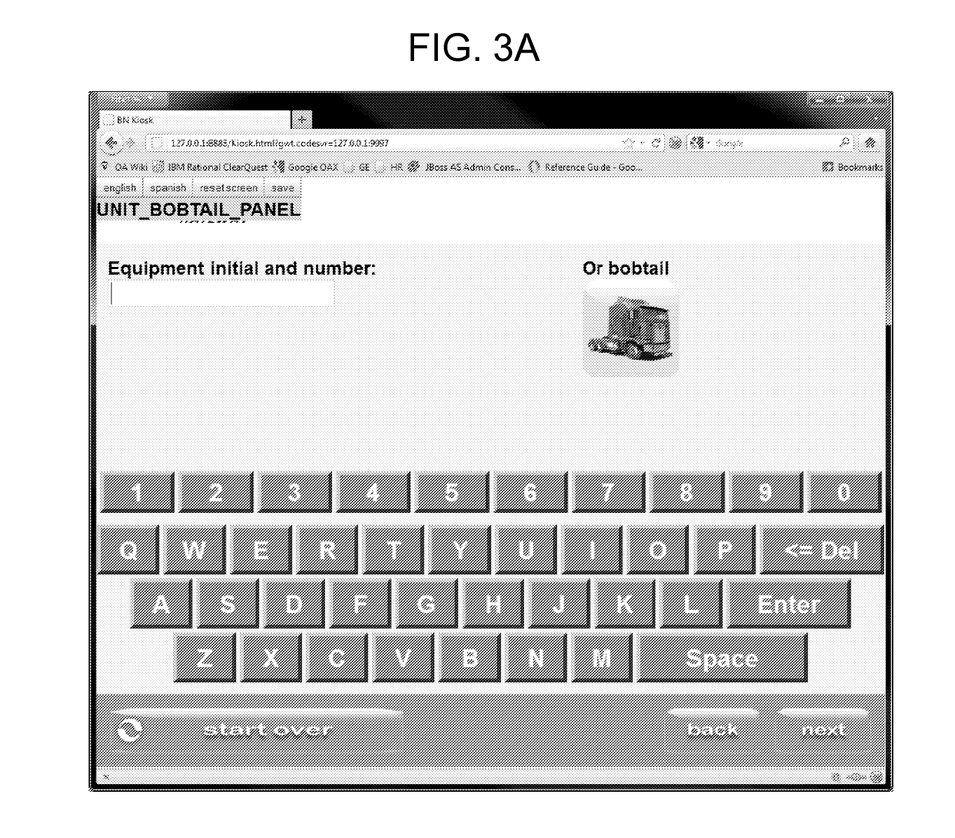

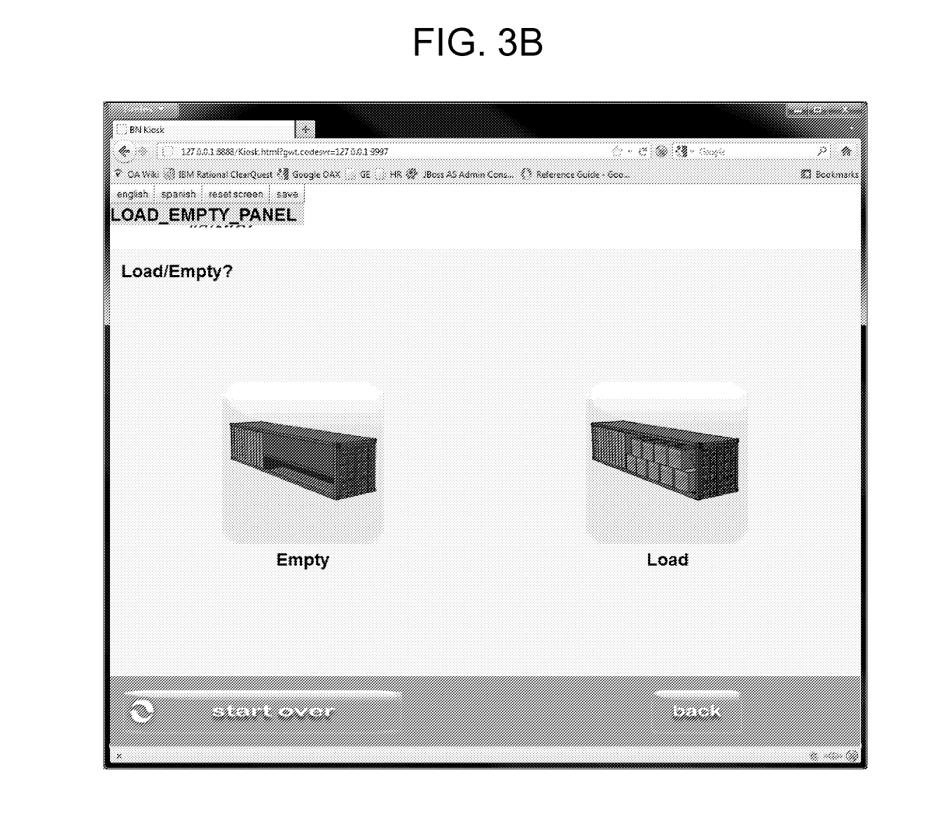

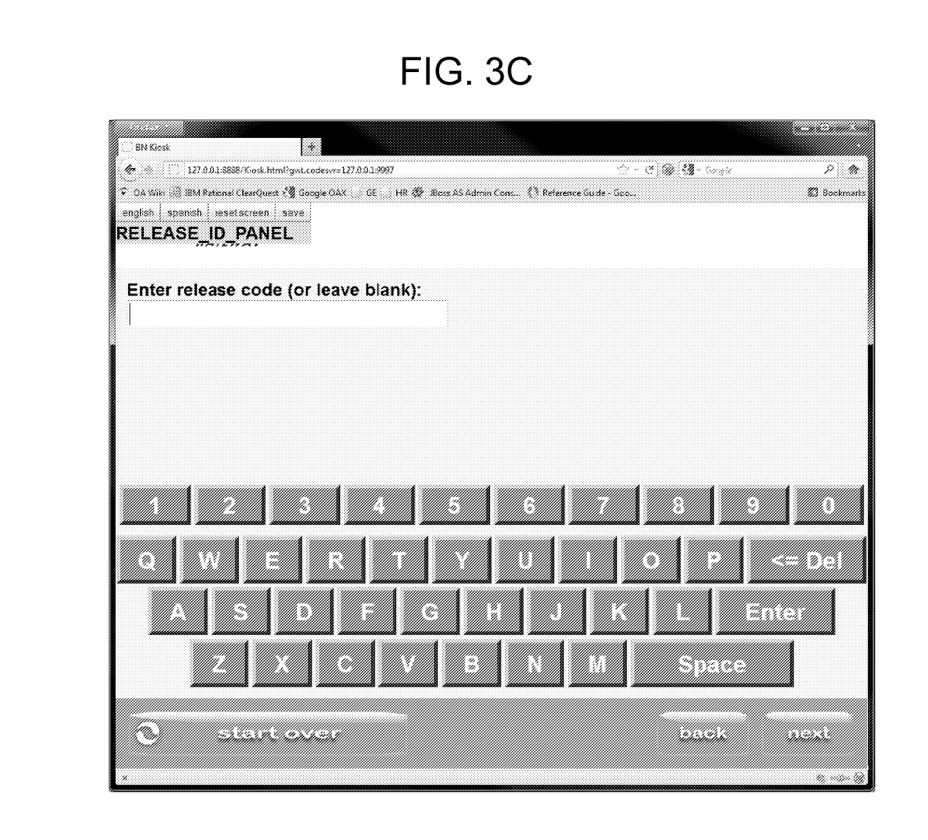

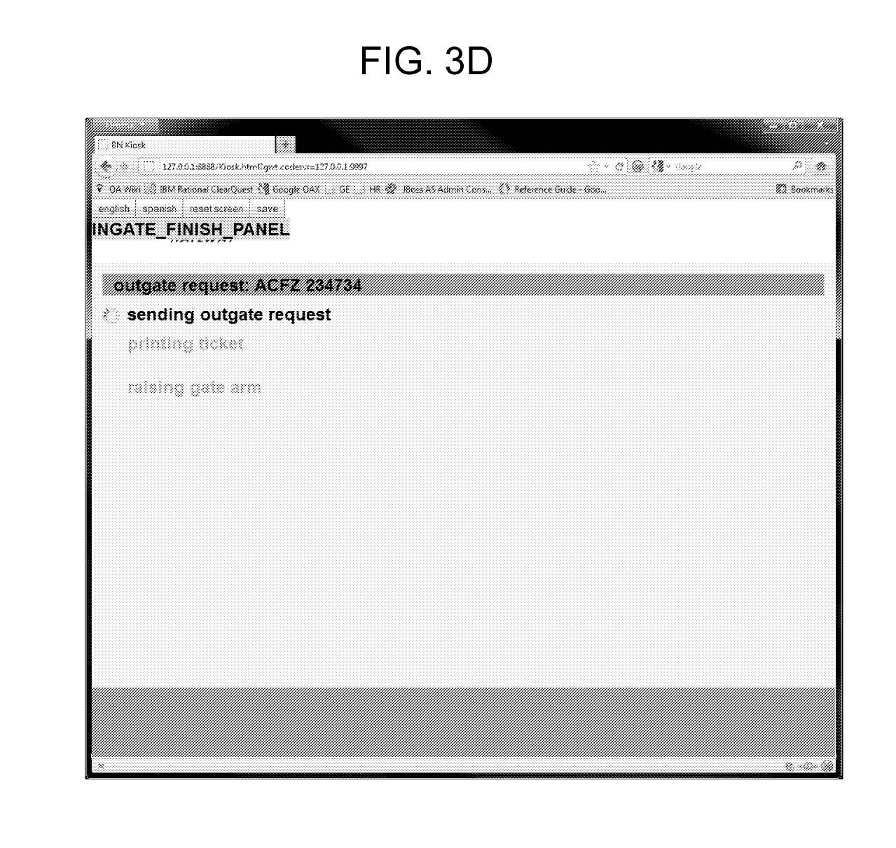

The system includes a gate kiosk 130 having a user interface (e.g., a touch-screen display) 135 and (in some embodiments) a printer 136. The gate kiosk also includes a processing element (not shown) and is configured to communicate with the terminal management controller either directly or via a computer network 140. The gate kiosk may be installed at an entrance gate or an exit gate of a shipping terminal, or at a gate that serves as both an entrance and exit. When a driver of a shipping vehicle arrives at an entrance gate of a shipping terminal with a shipping container or trailer to make a delivery, the driver may enter information into the gate kiosk and/or make selections using the gate kiosk via the touch-screen display, following a self check-in process (e.g., see FIG. 2). Similarly, when a driver of a shipping vehicle arrives at an exit gate of a shipping terminal with a shipping container or trailer to make a pick-up, the driver may enter information into the gate kiosk and/or make selections using the gate kiosk via the touch-screen display, following a self check-out process (e.g., see FIG. 3). The gate kiosk is positioned to allow the driver to remain in the cab of his shipping vehicle and reach out a driver side window to interact with the gate kiosk.

In accordance with an embodiment, information entered or selected by the driver via the gate kiosk is communicated to the terminal management controller. The terminal management controller employs at least a portion of the TMSA 115 to process the information to validate a delivery or a pick-up of a shipping container or trailer by the driver of the shipping vehicle. Upon completing the self check-in or self check-out process, the gate kiosk prints out an equipment interchange receipt (EIR) (e.g., a paper receipt) which the driver can take. The EIR verifies that the container or trailer was properly delivered or picked up by the driver. Upon check-in, the EIR may also provide information telling the driver where to park or unload the container or trailer (i.e., a parking location). Such information may include directions from the kiosk to the final destination.

The system may include a host transportation management system (TMS) 150 in operative communication with the terminal management controller via, for example, a computer network 160. The TMS 150 manages various aspects (e.g., scheduling, tracking, way billing, revenue accounting) of a larger transportation system such as, for example, a railroad. The TMS may communicate with a plurality of terminal management controllers at a plurality of shipping terminals (e.g., railroad terminals). The TMS receives way billing information (shipping information) from shippers for each driver and transportation vehicle associated with the system.

When a driver of a transportation vehicle arrives at a shipping terminal and proceeds to follow the check-in process using the gate kiosk, initial information (e.g., about the driver and/or the shipment) is entered or selected by the driver via the gate kiosk and communicated to the terminal management controller 110, and then to the TMS 150 from the controller. The initial information entered by the driver may be a container number or a driver number, for example. The TMS extracts information from the way billing/waybill information associated with the driver and transportation vehicle and communicates that information back to the terminal management controller to automatically populate many of the data fields associated with the check-in process. In this manner, the self check-in process is simplified and streamlined for the driver.

The driver may then be directed to enter or select additional information such as, for example, hazmat information, seal number, and inspection information (e.g., a condition of the container or trailer as inspected and determined by the driver). Similarly, during the self check-out process, the TMS may provide way billing/waybill information associated with a pick-up the driver is to make at the shipping terminal, allowing the terminal management controller to auto-populate many of the data fields associated with the check-out process after the driver enters a pick-up number (authorization number) into the gate kiosk. Once the self check-in or self check-out process is completed and the driver takes the printed EIR, the gate opens and the driver is able to proceed into or out of the shipping terminal with the associated container or trailer.

In accordance with various other embodiments of the invention, the system may be configured in various other ways. For example, if the terminal management controller is on site at the shipping terminal, the gate kiosk may communicate in a direct wired manner with the controller, or via a communication network 140 which is a local area network. If the terminal management controller is remotely located from the shipping terminal, then communication with the gate kiosk may be via the internet. For example, the terminal management controller may be co-located with or be implemented on a same server computer as the TMS. As another example, the terminal management controller may be hosted at a third party site (e.g., a provider of the TMSA) as a software-as-a-service (SaaS) configuration. As a further example, the computer networks 140 and 160 may be the same network (e.g., the internet). Other configurations are possible as well, in accordance with various other embodiments of the invention and based on situation specific parameters.

FIG. 2 illustrates a flow chart of an exemplary embodiment of a method 200 of self check-in of a driver of a shipping vehicle arriving at a gate of a shipping terminal with a shipping container or trailer using the system of FIG. 1. During the self check-in process, the driver is presented with various screens or panels on the touch-screen display. The panels are presented in order and the driver, while sitting in the cab of his/her shipping vehicle and reaching out the window, enters information or makes selections at the direction of each screen or panel.

In accordance with an embodiment, the driver is initially presented with a welcome panel or home screen. Visiting the welcome panel triggers a reset of program logic (i.e., the program will dump the data about the previous driver and reinitialize in preparation for the new driver). The driver may select a language that the driver wants to use to communicate with the gate kiosk. After selecting a language (e.g., English), the next screen is a driver info panel where the driver may enter a license number and a personal identification number (PIN), for example. Entry requirements may vary by customer, however. A driver may not proceed without a correct PIN, in accordance with an embodiment. The driver information is confirmed in two steps. When the license number is entered, a check is performed to determine if there are multiple licenses that match the entered license number. If so, then the gate kiosk takes the driver to the duplicate driver panel where the system attempts to discern between the multiple licenses.

As shown in the flowchart of FIG. 2, the gate kiosk takes the driver through a plurality of screens or panels as part of the self check-in process. FIGS. 2A-2V illustrate exemplary embodiments of screens or panels associated with the method of self check-in of FIG. 2 and provided by the system of FIG. 1.

FIG. 2A illustrates a home screen or welcome panel of the self check-in process. When a user visits the screen of FIG. 2A, a reset of program logic is triggered. That is, data with respect to a previous user of the kiosk is dumped and re-initialization is performed in preparation for the current user. The user may use the home screen to select a language for interaction with the kiosk (e.g., English or Spanish).

FIG. 2B illustrates a driver information panel of the self check-in process. In accordance with an embodiment, a user (driver) may enter a driver license number and a PIN. The driver information is confirmed in two steps. When the license number is entered, the terminal management controller is accessed to check the license number. The controller may access the transportation management system (TMS) or some other server platform to check the license number. If multiple licenses are found that match the entered license number, the user is directed to the duplicate driver panel of FIG. 2C to select the appropriate state (e.g., Texas) associated with the user's driver license.

FIG. 2D illustrates a company panel of the self check-in process. If a driver is registered with more than one drayage company, the driver may select which drayage company they are working for from a pre-populated list. The list may be obtained from a driver database during the driver license inquiry, in accordance with an embodiment. The company panel may be skipped if the driver is registered with only one drayage company.

FIG. 2E illustrates a unit start panel of the self check-in process. In accordance with an embodiment the driver may select bobtail (0 units), single unit (one unit), or multiple units (two units). Such selection lets the system know how many carrier units, if any, the driver is hauling. FIG. 2F illustrates a unit number panel of the self check-in process. The unit number panel allows a user to enter a unit number associated with one in-gated unit. In accordance with an embodiment, a database is accessed to lookup the waybill information for that unit based on the entered unit number. For multiple units, a user may enter a unit number for each successive unit by using the NEXT option.

FIG. 2G illustrates a waybill confirm panel of the self check-in process. If the unit number entered by the user is not associated with waybill information (i.e., is not billed), the user may be asked to confirm that the correct unit number was entered. If the waybill information is not found, or the type of equipment in the waybill information is not known, the user may be directed to enter the equipment type using the unit type panel of FIG. 2H. Equipment type selections includes those of container, bare chassis, and trailer.

If a user enters an equipment type or the length of the equipment was not found in the waybill information, the user is subsequently directed to select the length of the equipment as illustrated by the length panel of FIG. 2I (e.g., 40 feet). If the unit type is that of container, then the user is directed to enter the initial and number of an associated chassis as illustrated in the mate panel of FIG. 2J. A database may then be accessed to lookup chassis information based on the entered initial and number.

FIG. 2K illustrates a shipper panel of the self check-in process. The shipper panel allows a user to select the shipper associated with the unit. The text field of the shipper panel provides an auto-complete list of shippers. As the user types more characters, the auto-complete field trims down the list of selections. If the shipper information is available as part of the waybill information, the shipper panel may be skipped by the user.

FIG. 2L illustrates a destination panel of the self check-in process. The destination panel allows a user to select a destination for the unit (e.g., Atlanta). The text field of the destination panel provides an auto-complete list of destinations. FIG. 2M illustrates a load/empty panel of the self check-in process. The load/empty panel allows a user to select whether the in-gated unit is loaded or is empty. This panel can be accessed if the user has a container or a trailer. If the load/empty status is available as part of the waybill information, the load/empty panel may be skipped by the user.

FIG. 2N illustrates a hazmat panel of the self check-in process that is used to select whether a unit contains hazardous materials. This panel is accessible only if there is a loaded unit and if the hazmat status is not found in the waybill information.

FIG. 2O illustrates a placard verify panel of the self check-in process. If the user has indicated that a unit contains hazardous material, the user is directed to indicate whether or not the hazmat placards on the unit are correct. If the hazmat placards on the unit are not correct, as indicated by the user, the user may be directed to a driver assistance booth.

FIG. 2P illustrates a seal panel of the self check-in process. In accordance with an embodiment, a user is directed to enter a seal number on the seal panel if they have a loaded unit to record the seal number of the seal that is physically attached to the unit. FIG. 2Q illustrates a roadability panel of the self check-in process where a user may enter roadability information for the chassis if they have a container or a bare chassis. The roadability panel allows a user to report any chassis defects, as may be required to be reported by federal or state regulation or equipment owner policy.

FIG. 2R illustrates a confirm panel of the self check-in process that allows the user to confirm the information for the in-gated unit. A user may update any incorrect information (e.g., unit ID, length, shipper, hazmat, unit type, load/empty status, destination, and seal). FIG. 2S illustrates a pickup choice panel of the self check-in process which allows a user to select a pickup option (e.g., check a booking, look up lot location, skip) to look up out-gate information, if desired. FIG. 2T illustrates a pickup unit panel of the self check-in process that allows a user to enter a unit number for pickup when the user selects “look up lot location”. A user is not allowed to pickup units that have stop conditions. A unit has to be in inventory with no stop conditions in order to be picked up.

FIG. 2U illustrates a pickup booking panel of the self check-in process that allows a user to enter a booking number to pick up a generic unit when the user selects “check a booking”. If there are multiple matches, a user may select a company/length for pickup. FIG. 2V illustrates an in-gate finish panel of the self check-in process where the kiosk sends the arrival request, print request, and gate arm request to the controller.

Some of the steps of the method may be performed in various orders, or at the same time, in accordance with various embodiments of the invention, and are not limited to any strict sequence that may be suggested by FIG. 2.

FIG. 3 illustrates a flow chart of an exemplary embodiment of a method 300 of self check-out of a driver of a shipping vehicle leaving from a gate of a shipping terminal with a shipping container or trailer using the system of FIG. 1. During the self check-out process, the driver is presented with various screens or panels on the touch-screen display. The panels are presented in order and the driver, while sitting in the cab of his/her shipping vehicle and reaching out the window, enters information or makes selections at the direction of each screen or panel.

Again, the driver is initially presented with a welcome panel or home screen. Visiting the welcome panel triggers a reset of program logic (i.e., the program will dump the data about the previous driver and reinitialize in preparation for the new driver). The driver may select a language which they want to use to communicate with the gate kiosk. After selecting a language (e.g., English), the next screen is a driver info panel where the driver may enter a license number and a PIN, for example. Entry requirements may vary by customer, however. A driver may not proceed without a correct pin number, in accordance with an embodiment. The driver information is confirmed in two steps. When the license number is entered, a check is performed to determine if there are multiple licenses that match the entered license number. If so, then the gate kiosk takes the driver to the duplicate driver panel where the system attempts to discern between the multiple licenses (refer back to FIGS. 2A-2D).

As shown in the flowchart of FIG. 3, the gate kiosk takes the driver through a plurality of screens or panels as part of the self check-out process. FIGS. 3A-3D illustrate exemplary embodiments of screens or panels associated with the method of self check-out of FIG. 3 and provided by the system of FIG. 1.

FIG. 3A illustrates a unit bobtail panel of the self check-out process. A user may enter a unit initial and number or select “bobtail”. If the user enters a unit, a database may be queried to retrieve information for that unit. As illustrated in the load panel of FIG. 3B, a user may select whether the out-gated unit is loaded or empty. This panel may be presented to the user when the unit type is not “bare chassis” and the load/empty field from the database lookup does not contain a valid value.

FIG. 3C illustrates a release ID panel of the self check-out process. A user may enter a release number that is validated by the controller. The user is not allowed to proceed if the release number is incorrect or if the unit has a stop order. FIG. 3D illustrates an out-gate finish panel of the self check-out process where the kiosk sends the out-gate request, print request, and gate arm request to the controller.

Some of the steps of the method may be performed in various orders, or at the same time, in accordance with various embodiments of the present invention, and are not limited to any strict sequence that may be suggested by FIG. 3.

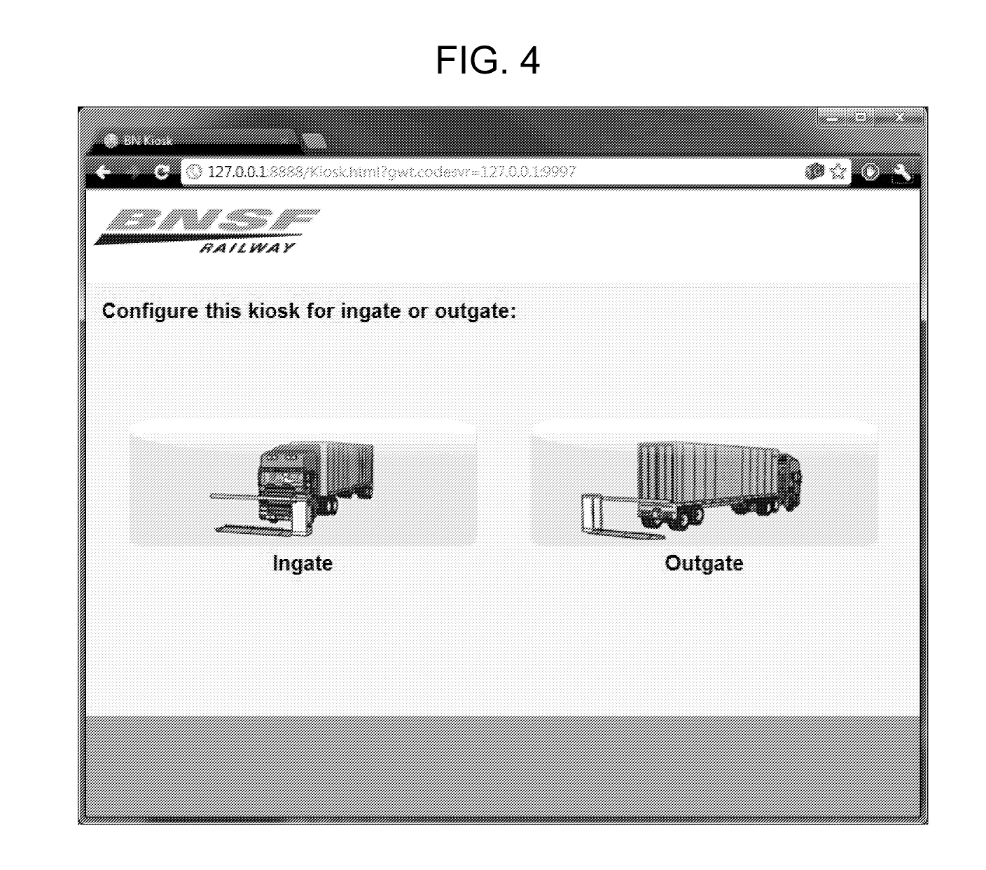

FIG. 4 illustrates an exemplary embodiment of a screen or panel provided by the system of FIG. 1 associated with configuring a gate kiosk of the system of FIG. 1. A technician may select to configure a gate kiosk to be an in-gate kiosk or an out-gate kiosk.

Systems and methods for facilitating the self check-in and self check-out of a driver of a shipping vehicle at a shipping terminal are disclosed. A gate kiosk located at a gate of a shipping terminal is provided which operably interfaces with a terminal management controller that manages transactions taking place within a shipping terminal. A driver may enter information and make various selections via a touch-screen display of the gate kiosk to check in or check out of the shipping terminal with a shipping container or trailer, without leaving the driver seat of the shipping vehicle.

Suitable kiosks can include standalone structures, optionally with ingress/egress controllers. Other suitable kiosks can be supported by other structures having differing purposes, such as an outward facing wall of a guard house. Ingress/egress controllers can include cross-bucks, gates, and the like. The ingress/egress controllers can be operationally coupled with the kiosk such that information exchanged through the kiosk may initiate one or more functions with the ingress/egress controller.

The kiosk information user interface can include a touch screen, as disclosed herein. Other suitable information exchange interfaces can include voice recognition, magnetic strips such as on a credit card, near field chips, radio frequency identification tags such as in an Automatic equipment identification (AEI) system, standard keyboards, biometric readers, and the like. Another suitable interface device includes a toll tag reader, and an antenna at the kiosk gate communicates with a transponder on the vehicle via dedicated short-range communication (DSRC) system. Yet another device is an automatic number plate recognition (ANPR) system that uses optical character recognition on images to read the license plates on the vehicle. These interfaces provide or transmit information to the kiosk data gathering system, and may be used alone or in combination.

Further, the kiosk may include readers that capture information distinct from transmitted or provided information from the container. That is, the kiosk may include weight scales, video capture devices, infrared monitors, radiation detectors, chemical vapor detectors, and the like. These other informative sensors may capture data about the arriving contain and/or vehicle. The kiosk system may then associate such captured data with information about the container (or its contents) in a database, and may initiate further actions based on the captured information. Such further actions may include sequestering a container if a chemical vapor (from its cargo) is detected. By sequestering, the unloading point of the cargo/container may change based on the sensor information to a point designated for handling leaking or defective containers.

Once the data from the driver is captured, in one embodiment, it may be compared against a database containing information about drivers. The database may be a governmental database, such as a driver licensing agency or a police database. Should there be a match of the driver's identification information, further action may be taken. For example, a driver who has a suspended license or a history of accidents may be refused entry to the shipping terminal

In one embodiment, the driver may indicate, the vehicle may indicate, and/or sensors in the kiosk may indicate that service or repair is suggested for the vehicle or for the cargo/container. If the vehicle signals to the kiosk that it is in need of fuel, the kiosk may initiate further actions. Examples of such further actions may include printing directions or location of a fueling depot, or schedule fuel delivery to the cargo/container unloading point (to simultaneously fuel and unload in some instances). A weight check of the cargo/container and vehicle may be checked against an expected weight to determine if the cargo has a weight about that which is expected, or that a vehicle that is supposed to be empty is not leaving with cargo it shouldn't be leaving with.

With reference to the touch screen, icons or symbols may be displayed that are replicas of hazardous material placards. The driver may indicate the nature of hazardous cargo by simply pressing on the icon that matches the placard on the vehicle.

With reference to the drawings, like reference numerals designate identical or corresponding parts throughout the several views. However, the inclusion of like elements in different views does not mean a given embodiment necessarily includes such elements or that all embodiments of the invention include such elements.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A system comprising:
a terminal management controller operable to manage transactions taking place within a shipping terminal; and
a gate kiosk, having a user interface, in operable communication with the terminal management controller and operable to facilitate at least one of self check-in or self check-out of an operator of a shipping vehicle at least one of arriving at or leaving the shipping terminal to deliver or depart with one or more shipping units.

2. The system of claim 1, wherein the gate kiosk includes a printer operable to print an equipment interchange receipt that memorializes delivery and/or departure of the one or more shipping units.

3. The system of claim 1, wherein the user interface includes one or more of a touchscreen display, a keyboard, or a voice recognition interface operable to allow the operator to at least one of make selections or enter information.

4. The system of claim 1, wherein the gate kiosk includes a radiation detector operable to detect radiation emitted by at least one of the shipping vehicle or the one or more shipping units.

5. The system of claim 1, wherein the gate kiosk includes a chemical vapor detector operable to detect chemical vapors emitted by at least one of the shipping vehicle or the one or more shipping units.

6. The system of claim 1, further comprising an ingress/egress controller coupled to at least one of the gate kiosk or the terminal management controller and operable to open and close a gate associated with the gate kiosk at the command of said at least one of the gate kiosk or the terminal management controller.

7. The system of claim 1, wherein:
the gate kiosk is positioned at a gate of the shipping terminal;
the gate kiosk is positioned at a height and with respect to a roadway by the gate to allow for operator access of the user interface through a driver side window of a cab of the shipping vehicle and without the operator leaving the cab; and
the gate kiosk is configured to automatically populate one or more data fields of the user interface associated with the self check-in and/or the self check-out based on first information received from the terminal management controller responsive to communication from the gate kiosk to the terminal management controller of second information entered by the operator via the user interface, wherein the one or more data fields that are automatically populated comprise one or more data fields of the user interface that the operator would have to fill in for the self check-in and/or the self check-out but for the automatic population.

8. A method comprising:
receiving first information at least one of selected at or entered into a gate kiosk at a gate of a shipping terminal, by an operator of a shipping vehicle transporting one or more shipping units, as part of at least one of a self check-in process or a self check-out process; and
processing the received first information to validate at least one of a delivery or a pick-up of the one or more shipping units by the operator of the shipping vehicle.

9. The method of claim 8, further comprising searching a database for waybill information associated with the received first information.

10. The method of claim 9, further comprising populating one or more data fields associated with the at least one of the self check-in process or the self check-out process with at least a portion of the associated waybill information.

11. The method of claim 8, further comprising printing an equipment interchange receipt in response to completing the at least one of the self check-in process or the self check-out process, wherein the equipment interchange receipt memorializes delivery and/or pick-up of the one or more shipping units.

12. The method of claim 8, further comprising opening the gate in response to completing the at least one of the self check-in process or the self check-out process, for the shipping vehicle to pass through the gate.

13. The method of claim 8, wherein the received information is at least one of selected at or entered into the gate kiosk via one or more of a touch screen, a voice recognition interface, or a keyboard.

14. The method of claim 8, further comprising automatically receiving second information from at least one of the shipping vehicle or the one or more shipping units into the gate kiosk without the operator having to select or enter the second information.

15. A system comprising:
means for a driver of a shipping vehicle, transporting one or more shipping units, to at least one of select or enter first information at one or more of an entrance gate or an exit gate of a shipping terminal without leaving a driver seat of the shipping vehicle;
means for receiving the at least one of the selected or entered first information; and
means for processing the received first information to determine if a gate of the shipping terminal blocking the shipping vehicle should or should not be opened to allow the driver to at least one of enter or leave the shipping terminal while driving the shipping vehicle.

16. The system of claim 15, further comprising means for printing an equipment interchange receipt to memorialize delivery and/or pick-up of the one or more shipping units.

17. The system of claim 15, further comprising means for detecting radiation emitted by at least one of the shipping vehicle or the one or more shipping units.

18. The system of claim 15, further comprising means for detecting chemical vapors emitted by at least one of the shipping vehicle or the one or more shipping units.

19. The system of claim 15, further comprising means for automatically receiving second information from at least one of the shipping vehicle or the one or more shipping units without the driver having to select or enter the second information.

20. The system of claim 15, further comprising means for accessing waybill information associated with at least one of the driver, the shipping vehicle, or the one or more shipping units.
